(19) United States
(12) Patent Application Publication
(10) Pub. No.: US 2021/0293685 A1
(43) Pub. Date: Sep. 23, 2021

(54) METHOD FOR EXAMINING A LIQUID SAMPLE AND A DISPENSING APPARATUS

(71) Applicant: cytena GmbH, Freiburg (DE)

(72) Inventors: Jonas SCHÖNDUBE, Freiburg (DE); Julian RIBA, Freiburg (DE); Kevin PFLEGHAR, Müllheim (DE)

(21) Appl. No.: 17/258,501

(22) PCT Filed: Jul. 9, 2019
(86) PCT No.: PCT/EP2019/068371

§ 371 Date: Jan. 7, 2021

(30) Foreign Application Priority Data
Jul. 9, 2018 (LU) LU100870

(51) Int. Cl. G01N 15/02; B01L 3/00

(52) U.S. Cl. CPC G01N 15/0205; B01L 3/56; B01L 3/50273

(57) ABSTRACT

The invention relates to a method for examining a liquid sample that has a liquid and at least one cell located in the liquid and/or at least one particle located in the liquid, wherein at least one data element containing information about a sample region is determined with the method. The method is characterised in that the data element is supplied to a trained algorithm that generates a result dependent on the data element, and in that a dispensing process comprising the discharging of at least part of the liquid sample depends on the result.

### CROSS-REFERENCE TO RELATED APPLICATIONS

The present application is the U.S. national phase of International Application No. PCT/EP2019/068371 filed Jul. 9, 2019, which claims the benefit of and priority to Luxembourgian Patent Application No. 100870 filed Jul. 9, 2018, the entire disclosure of which is incorporated herein by reference.

### FIELD

The disclosure relates to a method for examining a liquid sample that has a liquid and at least one cell located in the liquid and/or at least one particle located in the liquid, wherein at least one data element containing information about a sample region is determined with the method. The disclosure also relates to a dispensing apparatus that comprises means for carrying out the method.

The disclosure also relates to a computer program, a data carrier on which the computer program is stored and a data carrier signal that the computer program transmits.

### BACKGROUND

It is known from the prior art that active substances, such as monoclonal antibodies and other proteins, are produced with the aid of monoclonal cell lines. These are populations of cells that are all descended from a single parent cell. The production of monoclonal cell lines is necessary because this is the only way to ensure that all cells of the population have approximately the same genome to produce the active ingredients.

To produce a monoclonal cell line, cells are transferred individually into the containers of a microtitre plate. The cells to be transferred are produced by genetically modifying a host cell line and isolating these modified cells. Individual cells are deposited in the microtitre plates using, for example, free-jet pressure methods or pipetting.

Dispensing apparatus can be used to deposit the individual cells. Dispensing apparatus by means of which droplets of liquid can be discharged into the container are known from the prior art. It is known that before the liquid droplet is discharged, an examination is carried out to determine whether there are no cells or a single or more cells in the liquid droplet. Depending on the result of the examination, the droplet of liquid is discharged into a container or a reject container. After the dispensing process, the cells discharged into the containers can multiply in the respective container.

The disadvantage of the known dispensing apparatus is that the liquid droplets are discharged into the containers without the quality of the cells being checked. Therefore, it can happen that dead cells are introduced into the containers. This is disadvantageous because no cell cultivation will take place in the corresponding containers, which is disadvantageous due to the limited number of containers and the limited processing time. The cells can be checked manually before they are dispensed into the container, but this is not economical and is therefore not done in practice.

EP 2 042 853 A1 discloses an analysis apparatus in which a biological sample located between two glass plates is analysed using recorded images.

### SUMMARY

The object of the disclosure is therefore to improve the dispensing process.

The object is achieved by a method of the type mentioned at the outset, which is characterised in that the data element is supplied to a trained algorithm that generates a result dependent on the data element, and in that a dispensing process comprising the discharging of at least part of the liquid sample depends on the result.

In addition, the object is achieved by a dispensing apparatus that has means for carrying out the method.

In particular, the object is achieved by a dispensing apparatus that carries out a method for examining a liquid sample that has a liquid and at least one cell located in the liquid and/or at least one particle located in the liquid, with an optical detection device for generating at least one data element that contains information about a sample region, characterised in that the data element can be supplied to a trained algorithm, in particular stored in a classifier of the dispensing apparatus, which generates a result dependent on the data element, and in that a dispensing process comprising the discharging of at least a part of the liquid sample depends on the result.

The method according to the disclosure has the advantage that the trained algorithm makes a prediction or determines an estimated value that influences the dispensing process automatically, i.e. without the involvement of a laboratory employee. Based on the supplied data element, the trained algorithm can, for example, predict whether the cell discharged with the liquid will soon die off, or it can be estimated whether the cell to be dispensed is a dead cell. This knowledge is advantageous because the dispensing into containers of dead cells or cells for which the probability of death is high is prevented in a simple manner in this way. Rather, it can be ensured that such cells are discharged into a reject container. As a result, the efficiency of the laboratory operation increases due to the trained algorithm. This is possible because the cell quality and/or particle quality is taken into account during the dispensing process.

The liquid sample discharged by means of the dispensing apparatus can be an, in particular free-flying, droplet. Alternatively, the discharged liquid sample can be a liquid jet, which, after being discharged from a dispenser of the dispensing apparatus, disintegrates into individual liquid droplets. The dispensing apparatus can be a droplet generator. The dispensed liquid has a volume in a range between 1 pl (picolitres) to 50 nl (nanolitres).

The discharged liquid sample can include no cells and/or no particles. Alternatively, the discharged liquid sample can include a single cell and/or a single particle. The discharged liquid sample can alternatively include more than one single cell and/or more than one single particle.

The liquid of the liquid sample can have a composition that is conducive to cell growth. The particle can be a glass or polymer bead and have substantially the same volume as the cell. The cell is a biological cell, in particular the cell is the smallest unit of life that is autonomously capable of reproduction and self-preservation.

A trained algorithm is an algorithm that can assess data, such as the supplied data elements, on the basis of a learned knowledge. To be able to assess the data, the algorithm must first be subjected to a training described in detail below. In the training, the algorithm learns using examples and can generalise them after the learning phase has ended. This means that the algorithm does not learn the examples by rote, but recognises patterns and/or regularities in the training data. This also enables the algorithm to assess unknown data, such as the data element.

In a particular embodiment, it can be checked whether a predetermined number of cells and/or particles is arranged in the sample region. In particular, an evaluation device of the dispensing apparatus can be used to determine whether a single cell and/or a single particle is arranged in the sample region. In addition, the evaluation device can be used to determine whether there are no cells and/or no particles in the sample region. Alternatively or additionally, the evaluation device can be used to determine whether more than one cell and/or one particle is arranged in the sample region.

Alternatively or additionally, the number of cells and/or particles arranged in the sample region can be determined by the trained algorithm. In addition, the algorithm can check whether the predetermined number of cells and/or particles is arranged in the sample region.

Alternatively, the number of cells and/or particles arranged in the sample region can be determined by another trained algorithm. In addition, the other trained algorithm can be used to check whether the predetermined number of cells and/or particles is contained within the sample region. The result of the determination and/or testing by the other trained algorithm can be transmitted to the trained algorithm.

By checking whether there is at least one cell and/or at least one particle in the sample region, it is known whether there is a certain number of cells and/or particles is arranged in the liquid sample to be dispensed in the next step or in the liquids to be dispensed in the next steps. In particular, it is known whether no or one or more cells and/or no or one or more particles are arranged in the droplet or plurality of droplets to be dispensed.

Knowing the number of cells and/or particles located in the sample region also has the advantage that this information is used to decide whether the data element is to be supplied to the trained algorithm. In particular, the data element is supplied to the trained algorithm if there is a single cell and/or a single particle in the sample region. This is done because it is advantageous for the further investigation if only a single cell and/or a single particle is contained in the container. Therefore, only a liquid sample in which only a single cell and/or a single particle is arranged will be supplied to the container. The container can be part of a microtitre plate.

Alternatively, the number of cells and/or particles arranged in the sample region can be determined by an algorithm that cannot be trained. This offers the advantage that a complex training phase is not necessary for the algorithm to determine the number of cells and/or particles.

If the sample region does not contain any cells and/or particles or if the sample region does not contain the predetermined number of cells and/or particles are contained, the data element cannot be supplied to the trained algorithm or the trained algorithm will terminate further processing of the data element to determine the result. This offers the advantage that the computational effort is reduced because the trained algorithm is only used and/or the data element is only processed further if the sample region contains a single cell and/or a single particle in the liquid. In this case, the liquid sample can be discharged into the reject container.

The data element can contain one or a plurality of pieces of information about the sample region. In particular, the data element can be a measurement signal or an optical signal or an image signal. The data element can contain at least one piece of information on a cell property of the cell arranged in the liquid of the sample region and/or a particle property of the particle arranged in the liquid of the sample region.

In a further embodiment, an image can be generated from the image signal. The dispensing apparatus can have an optical detection device, such as a camera, which is used to generate an image of the sample region. When a plurality of data elements, in particular a plurality of image signals, is determined, in particular staggered in time, a plurality of images can be generated. In particular, the image can show a dispenser of the dispensing apparatus receiving the sample region or a part of the dispenser receiving the sample region. In particular, the image can show a discharge channel or part of the discharge channel of the dispenser. The data element, in particular the image signal, contains all of the necessary information that is necessary to generate the image.

The dispenser can be used to discharge the liquid sample. In particular, the sample region is discharged or can be discharged by the dispenser.

The image can be a bright field image or fluorescence image or dark field image or phase contrast image. It is possible that a plurality of images shows the same cell, but from different angles and/or at different times.

Only part of the data element can be supplied to the trained algorithm. In this case, an image section can be determined that includes the cell and/or the particle. Only that part of the image signal comprising the image section can be supplied to the trained algorithm. This offers the advantage that the trained algorithm need not examine the entire image signal, but only that part of the image signal containing the image section. This reduces the computing effort. Alternatively or additionally, the data element can only be supplied to the trained algorithm if the predetermined number of cells and/or particles is contained in the sample region. The data element can be supplied to the trained algorithm if the sample region contains a single cell and/or a single particle.

The position of the cell and/or the particle in the sample region and/or the image can be determined. This can occur by means of a further algorithm. The position of the cell and/or the particle can be determined in a simple manner by evaluating the generated image. After the position of the cell and/or the particle in the image is known, the image section described above can be generated. The image section can completely contain the cell and/or the particle. The image section can have a predetermined size.

In a particular embodiment, the dispensing process can also include determining a storage location for the liquid sample to be dispensed, in particular the droplet. It can thus be ensured in a simple manner that, for example, dead cells are discharged into the reject container, while, on the other hand, living cells are discharged into different containers. After the storage location has been determined, the liquid sample can be dispensed into the container or reject container.

The sample discharge can be carried out according to a drop-on-demand mode of operation. In this case, the dispensing apparatus provides a discrete and not a continuous sample discharge. To implement the drop-on-demand mode of operation, the dispensing apparatus can have an actuating means, for example, which can be a piezoelectrically operated actuator. The dispenser can have a section, in particular a mechanical membrane, which can be actuated by the actuating means. When the actuating means is actuated, the liquid sample, in particular a droplet, is ejected from the dispenser.

The trained algorithm can be part of an artificial neural network and/or an artificial neural network can be part of the trained algorithm. This makes it possible to determine in a particularly simple manner whether the cell and/or the particle is to be dispensed into the reject container or the container. An artificial neural network is understood to be a collection of individual information processing units, which are referred to as neurons and which are arranged in layers in a network architecture.

In a particular embodiment, the algorithm can be a convolutional neural network for classifying images that can be generated from the data element as described above. The neural network is also referred to as a convolutional neural network. The convolutional neural network consists of at least one convolutional layer, at least one hidden layer, and at least one fully networked layer.

As an alternative to the neural network, another trainable algorithm can also be provided. The algorithm can be a support vector machine (e.g. a 2-norm SVM), a linear regression, a boosting network, a probabilistic boosting tree, a linear discriminant analysis, a relevance vector machine, a random forest method, a nearest neighbour method, or a combination thereof.

The result of the trained algorithm can depend on a classification of the data element into one of at least two classes. The classes can depend on a cell property and/or particle property. By classifying the data element into a class, a prediction of the cell property and/or particle property is made or an estimated value for a cell property and/or particle property is determined. The estimated value can be, for example, a probability value of whether the cell is dead or an estimate of a diameter of the cell and/or particle. Accordingly, the result can be a prediction of the cell property and/or the particle property or the estimated value for the cell property and/or the particle property.

The cell property can be the cell type, the productivity of the cell, a genotype or phenotype, a status of a cell cycle and/or a condition of the cell. The classes specify the respective cell property. Thus, in the case where the cell property is the cell state, one class can concern “living cells” and another class “dead cells”. Alternatively or additionally, classes are conceivable that depend on whether the cell is stained or not, or whether the cell is intact or not. In addition, classes are conceivable that depend on whether high or low gene expression or protein production, in particular certain proteins, is possible or present, or whether the cells grow or divide quickly or slowly. In addition, classes are conceivable in which a classification takes place according to whether there is a high or low probability that high-quality results will be achieved in a subsequent molecular analysis. Such a molecular analysis can, for example, be the sequencing of the entire genome or parts of the genome and/or the entire transcriptome or parts of the transcriptome of the individual dispensed cells.

The trained algorithm can make a prediction of the cell property and/or particle property and/or estimate the cell property and/or particle property by applying the learned knowledge to the generated image. By using the trained algorithm, for example, it can be estimated whether the cell shown in the figure is dead or alive. This allows the algorithm to be used to maximise the number of living cells that will grow into a colony after isolation.

The data element can be classified into a class by means of a classifier. The classifier can be part of the artificial neural network and/or an artificial neural network is part of the classifier.

In a particular embodiment, the algorithm can be trained in a training process before the data element is supplied to the algorithm. The algorithm can be trained using machine learning. The purpose of the training process is to acquire knowledge that enables the data elements supplied to be assessed. In machine learning, knowledge is artificially generated from experience. This is achieved, as will be described below, by feeding a large amount of training data into the algorithm.

At least one class can be assigned to the individual training data elements before they are supplied to the algorithm. The assignment of the individual training data elements to the respective classes can be based on measurement data. The measurement data can be based on liquid samples discharged from the dispensing apparatus that have a single cell and/or a single particle.

During the training process, a plurality of first training data elements and a plurality of second training data elements can first be determined. The first training data elements can each contain at least one piece of information about the sample region. The second training data elements can each contain at least one piece of information about the cell property and/or particle property. At least one second training data element can be assigned to a first training data element.

The first training data elements can be determined when the sample region and/or the liquid sample is in the dispenser. Alternatively, the first training data elements can be determined when the dispenser has discharged the sample region and/or the liquid sample and the sample region and/or the liquid sample is located in the container.

The second training data elements can be determined chronologically after the first training data elements have been determined. The second training data elements are preferably determined after the liquid sample and/or the sample region has been discharged into the container. The determination of the second training data elements, in particular the measurement of the cell property and/or the particle property, can be carried out after a predetermined period, in particular several days, after the liquid samples have been discharged into the containers. After the second training data elements have been determined, at least one second training data element can be assigned to each first training data element. The assignment can be automated, for example via a computer program, or be carried out by the laboratory employee.

A large number of images can be generated from the first training data elements. At least one cell property, such as the cell state, the cell type, etc., can be assigned to each of the images.

At least two classes can also be formed during the training process. The classes can depend on the second training data elements. In particular, the classes can depend on the cell properties and/or particle properties. It is thus conceivable that different classes are formed for different cell types and/or that different classes are formed depending on the cell state. The classes can be created manually. Alternatively, the classes can also be created automatically. After the classes have been formed, the individual second training data elements can each be assigned to a class.

The first training data elements, the second training data elements and the assignment thereof to the first training data elements, and the classes formed are supplied to the algorithm for training the algorithm. The aim of the training is for the algorithm to recognise existing patterns and/or principles between the first training data elements and the second training data elements, and it is thus possible for it to classify data elements supplied in future. The cell property and/or particle property can thus be easily predicted or estimated in the laboratory using the classification of the data element in the corresponding class.

The trained algorithm can be retrained. On the one hand, this is useful if a cell type is used that has different properties, such as a different morphology, than the cell types with which the algorithm was previously trained. On the other hand, this is useful if, for example, only classes dependent on the cell state were formed in a first training process and a classification according to another cell property is desired. So that a classification according to the second cell property is possible, a second training process must be carried out in which, for example, classes dependent on cell types are formed. After performing the two training processes, the algorithm is able to classify data elements according to cell types and according to cells with different cell growth.

The dispensing apparatus can have a displacement device by means of which the dispenser and/or the container for receiving the liquid sample and/or the reject container for receiving the liquid sample can be displaced for receiving the liquid sample, wherein a displacement process is dependent on the result, in particular on the classification of the data element. For example, the displacement device will displace the dispenser in such a way that the liquid sample is discharged into the reject container if the data element has been classified into a class in which, for example, dead cells are classified.

In addition, the dispenser and/or the container and/or the reject container can be displaced by means of the displacement device in such a way that the liquid sample is discharged into the reject container if no cells and/or no predetermined number of cells and/or particles are contained in the discharged liquid sample. By contrast, the discharged liquid can be discharged into the container if a single cell and/or a single particle is arranged in the liquid.

The dispensing apparatus can have a deflection and/or suction device. The deflection device is used for deflecting the discharged liquid sample, in particular the discharged droplet. The suction device is used for suctioning off the discharged liquid sample, in particular the discharged droplet. The discharged liquid sample can be deflected and/or suctioned off into the reject container. Alternatively, the discharged liquid sample can be dispensed into the container, in particular the container of the microtitre plate.

The deflection and/or suctioning can take place before the discharged liquid sample enters the container, in particular the container of the microtitre plate. The discharged liquid sample can be deflected and/or suctioned off if no cells and/or no particles are arranged in the discharged liquid. Alternatively, the discharged liquid can be deflected and/or suctioned off if the number of cells and/or particles arranged in the liquid is greater than a predetermined value, in particular greater than 1.

In addition, the deflection and/or suctioning off can depend on the result of the trained algorithm. In particular, the deflection and/or suctioning off can depend on the class into which the data element was classified. If the data element is classified into a class in which, for example, dead cells are classified, the deflection and suction apparatus is activated so that the discharged liquid sample is deflected and/or suctioned off.

A computer program is particularly advantageous that comprises commands that, when the program is executed by a computer, cause the computer to carry out the method according to the disclosure. A data carrier on which the computer program according to the disclosure is stored is also advantageous. In addition, a data carrier signal that transmits a computer program according to the disclosure is advantageous.

### BRIEF DESCRIPTION OF THE DRAWING VIEWS

The subject matter of the disclosure is shown schematically in the figures, wherein elements that are the same or have the same effect are mostly provided with the same reference symbols. In the figures:

FIG. 1 shows a dispensing apparatus according to the disclosure,

FIG. 2 shows an enlarged illustration of part of a dispenser of the dispensing apparatus according to the disclosure,

FIG. 3 shows a sequence in a training process for training an algorithm, and

FIG. 4 shows a method sequence for examining the liquid sample by means of the trained algorithm.

### DETAILED DESCRIPTION

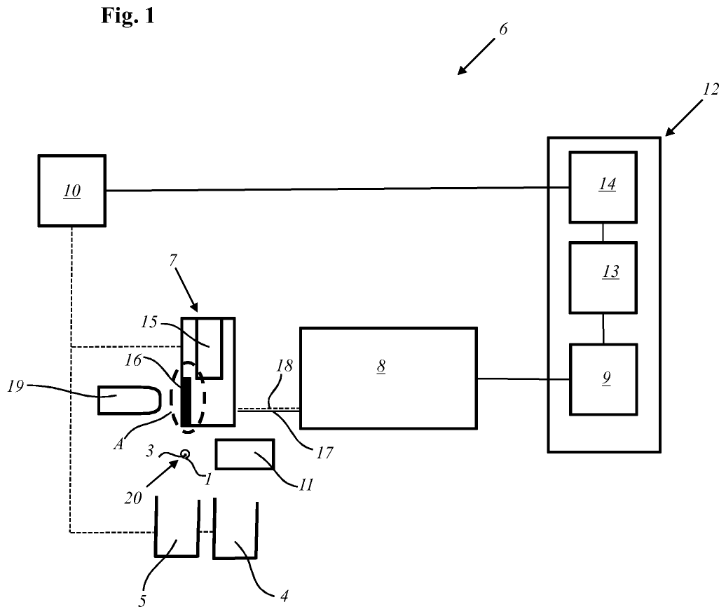

FIG. 1 shows a dispensing apparatus 6 according to the disclosure that has a dispenser 7 for discharging a liquid sample 20. The liquid sample 20 has a liquid 1 and at least one cell 3 arranged in the liquid 1 and/or at least one particle arranged in the liquid 1. In addition, the dispensing apparatus 6 has an optical detection device 8 for the optical detection of at least part of a discharge channel 16 of the dispenser 7. The dispenser 7 can have a fluid chamber 15 in which the liquid sample 20 is arranged and/or is introduced. The liquid chamber 15 is fluidically connected to the discharge channel 16.

The optical detection device 8 has an imaging device (not shown), such as a camera, for generating an image of the at least one part of the discharge channel 16 and further optical elements (not shown) for the guiding of light. To generate an image, the at least one part of the discharge channel 16 is illuminated by means of an illumination light 17 and a detection light 18 emanating from the at least one part of the discharge channel 16 is detected by the optical detection device 8. The imaging device generates an image of the at least one part of the discharge channel 16 based on the detected detection light 18.

The optical detection device 8 is electrically connected to an evaluation device 9 of a computer 12. The evaluation device 9 can determine the number of cells 3 and/or particles contained in the at least one part of the discharge channel 16 based on the generated image.

The computer 12 has a classifier 13 that is electrically connected to the evaluation device 9. The classifier 13 is part of an artificial neural network and/or has an artificial neural network. In the classifier 13 is stored an algorithm that generates a result after the image generated by the optical detection device 8 has been generated.

In addition, the computer 12 has a control apparatus 14. Based on the result from the classifier 13, the control apparatus 14 controls a dispensing process of the dispenser 7. The control apparatus 14 is electrically connected to a displacement device 10. The displacement device 10 can displace the dispenser 7 and/or a container 4 and/or a reject container 5 in such a way that the liquid sample 20 can be discharged into the desired storage location.

In addition, the control apparatus 14 can control a deflection and/or suction device 11 of the dispensing apparatus 6. The control apparatus 14 can control the deflection and/or suction device 11 in such a way that the dispensed liquid sample 20 is deflected and/or suctioned off if no cells 3 and/or no particles are arranged in the liquid 1 or if a plurality of cells 3 and/or a plurality of particles is arranged in the liquid 1.

In this case, the control apparatus 14 can control the displacement device 10 and/or the deflection and/or suction device 11 depending on the result of the classifier 13.

FIG. 1 shows a state in which the dispenser 7 has discharged the liquid sample 20, in particular a droplet, which includes a dead cell 3. The discharged liquid sample 20 is discharged into the reject container 5.

The dispensing apparatus 6 has an actuating means 19, which is pressed against a section of the dispenser 7 to actuate the dispenser 7. The liquid sample 20, in particular a droplet, is discharged when the actuating means 19 presses against the section of the dispenser 7. The actuating means 19 and the optical detection device 8 lie opposite one another with respect to the dispenser 7. The dispenser 7 consists at least partially of a transparent material, so that at least part of the discharge channel 16 can be detected by means of the optical detection device 8.

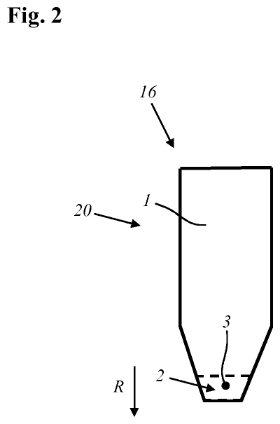

FIG. 2 shows an enlarged illustration of part of the dispenser 7. In particular, FIG. 2 shows an enlarged illustration of the region A of the discharge channel 16 shown in dashed lines in FIG. 1.

The discharge channel 16 is completely filled with liquid 1 of the liquid sample 20. In this case, only that part of the discharge channel 16 shown in dashed lines in FIG. 2 is viewed by means of the optical detection device 8. The sample region 2 of the liquid sample 20 is arranged in the part of the discharge channel 16 of the dispenser 7 shown in dashed lines. During a dispensing process, the liquid sample 20 is discharged along a deploying direction R. The discharge channel 16 has a nozzle-shaped end at the end thereof remote from that of the fluid chamber 15.

The cells 3 arranged in the part of the discharge channel 16 move due to the weight in the direction of the nozzle-shaped end facing away from the fluid chamber 15, even if no liquid sample 20 is discharged from the dispenser 7.

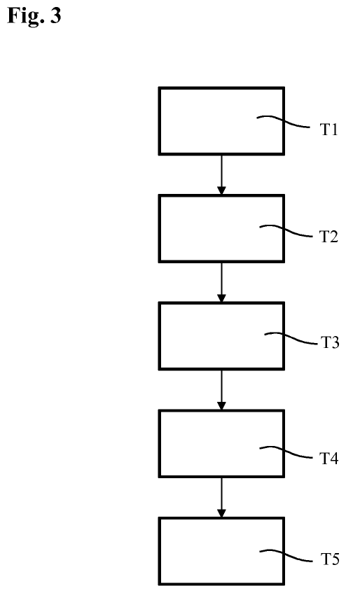

FIG. 3 shows a sequence in a training process for training an algorithm. The algorithm is stored in the classifier 13. A first training data element is determined in a first training step T1. The first training data element contains information on the sample region 2. The first training data element is determined by the optical detection device 8, wherein an image is generated from the first training data element in the optical detection device 8. The figure shows at least that part of the discharge channel 16 that receives the sample region 2.

After the first training data element has been determined, the liquid sample 20 is discharged into the container 4 of the microtitre plate by means of the dispenser 7 if the liquid sample 20 to be dispensed has a single cell 3 and/or a single particle. Another first training data element is then determined again, a further image is generated and the liquid sample 20 is discharged into a further container of the microtitre plate. This process is repeated several times. At the end of the first training step T1, a liquid 1 with a single cell 3 and/or a single particle is arranged in each container 4 of the microtitre plate, it being known which cell 3 is arranged in which container 4.

After the first training data elements have been determined, second training data elements are determined in a second training step T2. For this purpose, at least one cell property and/or particle property of the cell 3 located in the container 4 is measured. In particular, it can be measured how fast the cells 3 grow in the individual containers 4 and thus a conclusion can be drawn about the cell condition and/or it can be determined which cell types are contained in the containers 4. This is repeated for all containers in which a liquid sample 20 and thus a cell 3 is contained. The second training data elements can be determined a few days after the liquid samples 20 have been discharged into the containers 4. A microscope and/or an automated plate reader can be used to measure the cell property and/or the particle property.

In a third training step T3, at least two classes are formed. The classes depend on the second training data elements, in particular on the cell property and/or the particle property. The cell property can be a cell type, for example, so that the individual classes in the cell types differ from one another. Alternatively, the cell property can be the cell state so that the classes differ from one another in whether the cells are dead or alive. After the classes have been formed, the second training data elements are each assigned to at least one class. The third training step T3 can alternatively be carried out before the first and/or second training step T1, T2.

In a fourth training step T4, at least one second training data element is assigned to each first training data element. In particular, at least one cell property and/or particle property is assigned to each image of the sample region 2. Thus, in the fourth training step T4, the first training data element is linked to the second training data element. This link is advantageous because the algorithm can thus recognise the relationship between the first training data elements and the second training data elements. For example, the cell property “living cells” can be assigned to all first training data elements for which the measurement carried out in the second training step T2 has shown that the cell in the respective container is not dead and that cell growth is therefore taking place.

In a fifth training step T5, the classes are formed, and the first training data elements, the second training data elements and the assignment thereof to the first training data elements are used to train the classifier by means of machine learning. The algorithm uses the transmitted information to recognise at least one pattern and/or regularities between the first training data elements and the second training data elements. After the training process has been completed, a trained algorithm is available. This means that the trained algorithm can apply the knowledge it has learned to a supplied data element to use the data element alone to make a prediction or estimate of the cell property and/or the particle property.

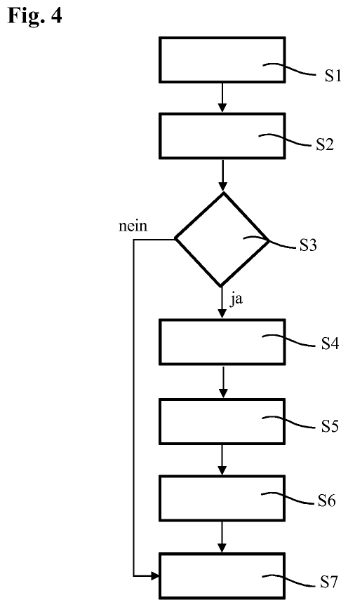

This is explained in more detail with reference to FIG. 4. FIG. 4 shows a method sequence for examining the liquid sample 20 by means of the trained algorithm. In a first method step S1, a data element is determined by means of the optical detection device 8. In addition, in the first method step S1, the optical detection device 8 generates an image from the determined data element that contains the sample region 2.

In a second method step S2, imperfections are removed from the image.

In a third method step S3, the evaluation device 9 checks whether the sample region 2 contains a predetermined number of cells 3 and/or particles. This is done using its own algorithm. In particular, the evaluation device 9 checks whether the sample region 2 contains exactly one single cell 3 and/or one single particle.

If it is determined that the sample region 2 contains a single cell 3 and/or a single particle, the position of the cell 3 and/or the particle in the image is determined in a fourth method step S4. Subsequently, in a fifth method step S5, an image section is generated which completely contains the cell 3 and/or the particle.

The image signal containing the image section is transmitted to the trained algorithm in a sixth method step S6. In a seventh method step S7, the trained algorithm generates a result based on the supplied image section. The result depends on a classification of the data element, in particular the image, into one of the classes stored in the trained algorithm. Since the classes depend on the cell property and/or particle property, a prediction of the cell property and/or particle property is made through the classification of the image into one of the classes. The image is classified into one of the classes by the classifier 13.

In a seventh method step S7, the control apparatus 14 controls the displacement device 10 and/or the deflection and/or suction apparatus 11 according to the result, in particular to the classification of the data element into a class.

If it was determined in the third method step S3 that there are no cells 3 and/or no particles in the liquid sample and/or the number of cells 3 and/or particles is greater than 1, the method steps S3 to S6 are skipped and the liquid sample 20 is discharged into the reject container 5 in the seventh method step S7.

### LIST OF REFERENCE SYMBOLS

1 Liquid
2 Sample region
3 Cell
4 Container
5 Reject container
6 Dispensing apparatus
7 Dispenser
8 Optical detection device
9 Evaluation device
10 Displacement device
11 Deflection and/or suction apparatus
12 Computer
13 Classifier
14 Control apparatus
15 Fluid chamber
16 Discharge channel
17 Illumination light
18 Detection light
19 Actuating means
20 Liquid sample
R Deploying direction
T1-T5 First to fifth training step
S1-S8 First to eighth method step

1. A method for examining a liquid sample (20) which has a liquid (1) and at least one cell (3) located in the liquid (1) and/or at least one particle located in the liquid (1), wherein at least one data element that contains information on a sample region (2) is determined with the method, wherein the data element is supplied to a trained algorithm that generates a result dependent on the data element, and wherein a dispensing process comprising the discharging of at least a part of the liquid sample (20) depends on the result, wherein the result is a prediction of a cell property and/or a particle property or an estimated value for a cell property and/or a particle property.

2. The method according to claim 1, wherein the method comprises checking whether a predetermined number of cells (3) and/or particles are arranged in the sample region (2).

3. The method according to claim 2, wherein
a. the data element is supplied to the trained algorithm when the predetermined number of cells (3) and/or particles is arranged in the sample region (2) and/or
b. the data element is not supplied to the trained algorithm if the predetermined number of cells (3) and/or particles is not arranged in the sample region (2) and/or
c. the number of cells and/or particles arranged in the sample region is determined by the trained algorithm or another trained algorithm, or
d. the number of cells and/or particles arranged in the sample region is determined by the trained algorithm or another trained algorithm and it is checked whether the predetermined number of cells (3) and/or particles is arranged in the sample region or
e. the number of cells and/or particles arranged in the sample region is determined by an algorithm that cannot be trained and it is checked whether the predetermined number of cells (3) and/or particles is arranged in the sample region.

4. (canceled)

5. The method according to claim 1, wherein
a. the data element is a measurement signal or an image signal and/or
b. only a part of the data element is supplied to the trained algorithm.

6. (canceled)

7. The method according to claim 5, wherein an image is generated from the image signal.

8. The method according to claim 7, wherein
a. the position of the cell (3) and/or of the particle in the image is determined or an image section is determined that has the cell (3) and/or the particle and only that part of the image signal containing the image section is supplied to the trained algorithm and/or
b. the image shows a dispenser (7) receiving the sample region (2) or a part of the dispenser (7) receiving the sample region (2).

9. (canceled)

10. The method according to claim 1, wherein
a. the dispensing process comprises determining a storage location for the liquid sample (20) to be dispensed and/or
b. the fluid discharge is carried out according to a drop-on-demand mode of operation and/or
c. the trained algorithm is part of an artificial neural network and/or contains at least one artificial neural network and/or
d. the result depends on a classification of the data element into one of at least two classes.

11. (canceled)

12. (canceled)

13. (canceled)

14. The method according to claim 1, wherein the algorithm is trained before the data element is supplied to the algorithm.

15. The method according to claim 14, wherein
a. a class is assigned to at least one training data element or
b. a class is assigned to at least one training data element and the class assignment of the training data element depends on measurement data based on a liquid sample that is dispensed.

16. (canceled)

17. The method according to claim 14, wherein the algorithm is trained by means of machine learning.

18. The method according to claim 14, wherein a plurality of first training data elements is determined and a plurality of second training data elements is determined.

19. The method according to claim 18, wherein
a. at least one second training data element is assigned to each first training data element and/or
b. at least two classes are formed depending on the second training data elements and/or
c. the classes and/or the first training data elements and/or the second training data elements are transmitted to the algorithm.

20. (canceled)

21. (canceled)

22. The method according to claim 1, wherein
a. the trained algorithm is retrained and/or
b. the data element contains information on a cell property of the cell arranged in the sample region and/or information on a particle property of the particle arranged in the sample region.

23. (canceled)

24. A dispensing apparatus (6) comprising means for carrying out the method according to claim 1.

25. The dispensing apparatus according to claim 24, comprising
a. a dispenser (7) for discharging the liquid sample (20) or a dispenser (7) for discharging the liquid sample (20) wherein the sample region (2) is arranged in the dispenser (7) and/or can be discharged by the dispenser (7) and/or
b. an optical detection device (8) for generating an image of the sample region (2) and/or
c. an evaluation device (9) for evaluating whether a predetermined number of cells (3) and/or particles are arranged in the sample region (2).

26. (canceled)

27. (canceled)

28. The dispensing apparatus (6) according to claim 24, comprising
a. a classifier (13) for classifying the data elements into a class or
b. a classifier (13) for classifying the data elements into a class wherein the classifier (13) is part of an artificial neural network and/or contains at least one artificial neural network.

29. (canceled)

30. The dispensing apparatus (6) according to claim 24, comprising
a. a displacement device (10) by means of which the dispenser (7) and/or a container (4) for receiving the liquid sample (20) and/or a reject container (5) can be displaced for receiving the liquid sample (20), wherein a displacement process depends on the result and/or
b. a deflection device for deflecting the discharged liquid sample (20) and/or a suction device for suctioning off the discharged liquid sample (20), wherein a deflection process and/or suction process depends on the result.

31. (canceled)

32. A non-transient computer readable storage medium comprising a computer program comprising instructions that, when the computer program is executed by a computer (12), cause the computer to carry out the method according to claim 1.

33. (canceled)

34. (canceled)
